(19) United States
(12) Patent Application Publication
(10) Pub. No.: US 2019/0369380 A1
(43) Pub. Date: Dec. 5, 2019

(54) SURVEYING INSTRUMENT

(71) Applicant: TOPCON CORPORATION, Tokyo (JP)

(72) Inventor: Daisuke ITO, Tokyo (JP)

(21) Appl. No.: 16/424,012

(22) Filed: May 28, 2019

(30) Foreign Application Priority Data
May 31, 2018 (JP) 2018-104483

(51) Int. Cl. G02B 23/16; G06F 3/16; G06F 3/01; G06K 9/00; G01S 17/08

(52) U.S. Cl. CPC G02B 23/16; G06F 3/16; G01S 17/08; G06K 9/00335; G06F 3/017

(57) ABSTRACT

Provided is a surveying instrument with a gesture interface. A surveying instrument includes a survey unit capable of surveying a target, an imaging unit capable of acquiring an image, an arithmetic control unit configured to control the survey unit and the imaging unit, and a storage unit, wherein the storage unit has input identification information in which an operator's predetermined action as a input gesture is associated with operations to the surveying instrument, and the arithmetic control unit includes an image recognition unit configured to recognize an input gesture from the image, and an image identification unit configured to identify an operation to the surveying instrument corresponding to the input gesture recognized by the image recognition unit as content meant by the input gesture.

### CROSS-REFERENCE TO RELATED APPLICATIONS

The present application claims priority under 35 U.S.C. § 119 to Japanese Patent Application No. 2018-104483 filed May 31, 2018. The contents of this application are incorporated herein by reference in their entirely.

### TECHNICAL FIELD

The present invention relates to a surveying instrument, more specifically, to a user interface of a surveying instrument.

### BACKGROUND ART

Conventionally, a user interface of a surveying instrument is a combination of display and key inputs, or touch panel inputs. For example, Patent Literature 1 discloses a surveying instrument including a touch panel type operation control panel configured to match an operator's operation feeling and operation of the instrument.

### CITATION LIST

### Patent Literature

Patent Literature 1: Japanese Published Unexamined Patent Application No. 2014-178274

### SUMMARY OF THE INVENTION

### Technical Problem

As described above, there are various proposed operation control panels that have improved operability as a man-machine interface, however, it is impossible to operate a surveying instrument without looking at the display, and it is difficult to look at the display because the display is small, dark, or has surface reflection in some cases.

There is another problem in which, when the instrument is equipped with a display and a keyboard, the instrument increases in size as a whole. At the time of input, a problem occurs in which, because an operator directly touches the surveying instrument, the surveying instrument may move from its installation location and its survey angle may change, or the surveying instrument vibrates in some cases. Therefore, it has been required to develop a surveying instrument having a gesture interface as a surveying instrument that an operator can operate without directly touching it.

The present invention was made in view of the above-described circumstances, and an object thereof is to provide a surveying instrument having a gesture interface.

### Solution to Problem

In order to achieve the above-described object, a surveying instrument according to an aspect of the present invention includes a survey unit capable of surveying a target, an imaging unit capable of acquiring an image, an arithmetic control unit configured to control the survey unit and the imaging unit, and a storage unit, wherein the storage unit has input identification information in which an operator's predetermined action as an input gesture is associated with an operation to the surveying instrument, and the arithmetic control unit includes an image recognition unit configured to recognize an input gesture from the image, and an image identification unit configured to identify an operation to the surveying instrument corresponding to the input gesture recognized by the image recognition unit as content meant by the input gesture.

A surveying instrument according to another aspect of the present invention includes a survey unit capable of surveying a target, a telescope including the survey unit, a horizontal rotation drive unit configured to rotate the telescope horizontally around a vertical axis, a vertical rotation drive unit configured to rotate the telescope vertically around a horizontal axis, an arithmetic control unit configured to control the survey unit, the horizontal rotation drive unit, and the vertical rotation drive unit, and a storage unit, wherein the storage unit has output conversion information in which output content for an operator is associated with an output gesture as an operation of the surveying instrument, and the arithmetic control unit includes a gesture making unit configured to convert output content for an operator into an output gesture based on the output conversion information, and make an output gesture by rotationally driving at least one of the horizontal rotation drive unit and the vertical rotation drive unit.

In the aspect described above, it is also preferable that the surveying instrument includes a telescope including the survey unit, a horizontal rotation drive unit configured to rotate the telescope horizontally around a vertical axis, a vertical rotation drive unit configured to rotate the telescope vertically around a horizontal axis, an arithmetic control unit configured to control the survey unit, the horizontal rotation drive unit, and the vertical rotation drive unit, and a storage unit, wherein the storage unit has output conversion information in which output content for an operator is associated with an output gesture as an operation of the surveying instrument, and the arithmetic control unit includes a gesture making unit configured to convert output content for an operator into an output gesture based on the output conversion information, and make an output gesture by rotationally driving at least one of the horizontal rotation drive unit and the vertical rotation drive unit.

In the aspect described above, it is also preferable that the surveying instrument includes a first illumination light emitting unit, wherein the gesture making unit is configured to express a gesture by controlling the first illumination light emitting unit.

In the aspect described above, it is also preferable that the surveying instrument includes a second illumination light emitting unit, wherein the second illumination light emitting unit is configured to illuminate the surveying instrument itself.

In the aspect described above, it is also preferable that the surveying instrument includes a third illumination light emitting unit, wherein the third illumination light emitting unit is configured to illuminate an operator who makes the input gesture.

In the aspect described above, it is also preferable that the surveying instrument includes a voice input unit and a voice output unit, wherein the arithmetic control unit includes a voice recognition unit configured to recognize voice input from the voice input unit, and a voice conversion unit configured to convert output content for an operator into a voice message, and output the voice message to the voice output unit.

### Effect of the Invention

According to the above-described configuration, it becomes possible to provide a surveying instrument with a gesture interface.

### BRIEF DESCRIPTION OF THE DRAWINGS

FIG. 1 is a configuration block diagram of a surveying instrument according to a first embodiment of the present invention.

FIG. 2 is a right perspective view of the surveying instrument according to the same embodiment.

FIG. 3 is a flowchart of gesture input in the surveying instrument according to the same embodiment.

FIG. 4 is a diagram illustrating examples of input identification information according to the same embodiment.

FIG. 5 is a flowchart of gesture output in the surveying instrument according to the same embodiment.

FIG. 6 is a diagram illustrating examples of output conversion information according to the same embodiment.

FIG. 7 is a flowchart of an as-built survey using a gesture interface of the surveying instrument according to the same embodiment.

FIG. 8 is a diagram illustrating examples of input identification information to be applied to the same as-built survey.

FIG. 9 is a flowchart of staking using the gesture interface of the surveying instrument according to the same embodiment.

FIG. 10 is a diagram illustrating examples of input identification information to be applied to the same staking.

FIG. 11 is a diagram illustrating examples of output conversion information to be applied to the same staking.

FIG. 12 is a configuration block diagram of a surveying instrument according to a second embodiment of the present invention.

FIG. 13 is a flowchart of input in the surveying instrument according to the same embodiment.

FIG. 14 is a flowchart of output in the surveying instrument according to the same embodiment.

### DESCRIPTION OF EMBODIMENTS

Preferred embodiments of the present invention are described with reference to the drawings. In the following embodiments described below, the same components are provided with the same reference sign, and overlapping description is omitted.

### First Embodiment

### (Configuration of Surveying Instrument)

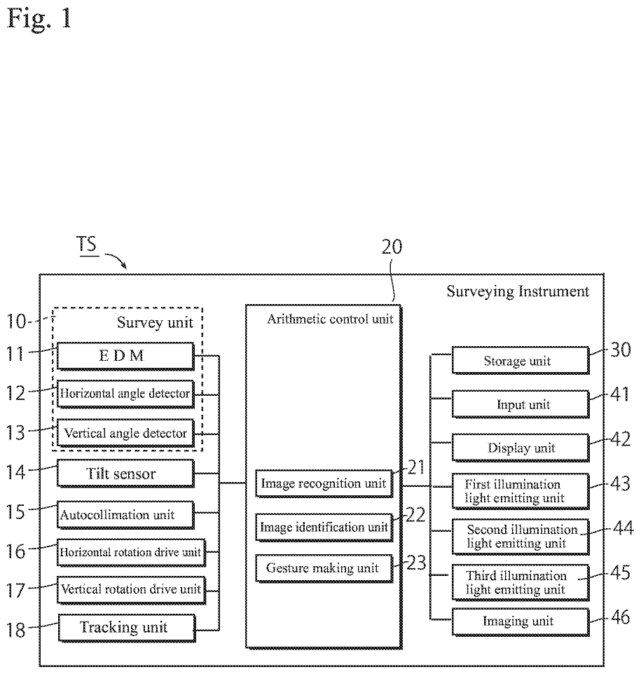

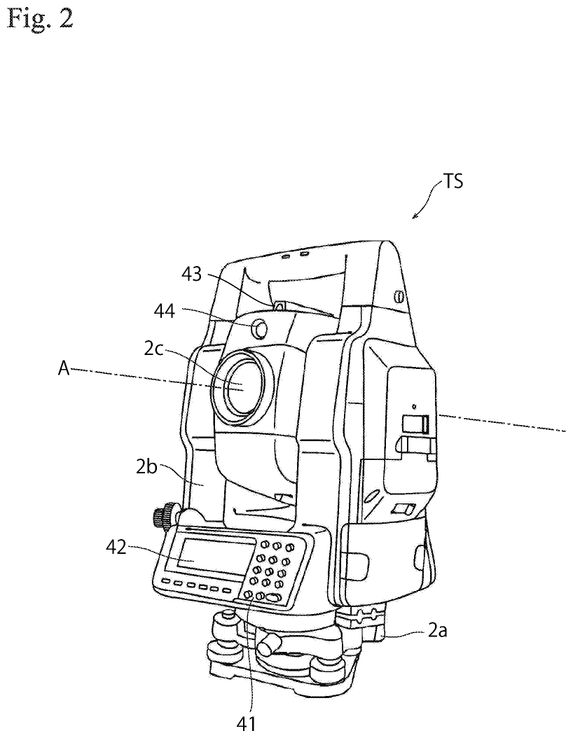

FIG. 1 is a configuration block diagram of a surveying instrument TS according to a first embodiment of the present invention, and FIG. 2 is a right perspective view of the surveying instrument TS.

The surveying instrument TS is a total station. As illustrated in FIG. 2, the surveying instrument TS includes, in appearance, a substrate portion 2a provided on a leveling apparatus, a bracket portion 2b that rotates horizontally on the substrate portion 2a, and a telescope 2c that rotates vertically at the center of the bracket portion 2b. The telescope 2c includes a collimation optical system that collimates a target.

In addition, the surveying instrument TS functionally includes, as illustrated in FIG. 1, an EDM 11, a horizontal angle detector 12, a vertical angle detector 13, a tilt sensor 14, an autocollimation unit 15, a horizontal rotation drive unit 16, a vertical rotation drive unit 17, a tracking unit 18, an arithmetic control unit 20, a storage unit 30, an input unit 41, a display unit 42, a first illumination light emitting unit 43, a second illumination light emitting unit 44, a third illumination light emitting unit 45, and an imaging unit 46.

The EDM 11 includes a light emitting element, a distance-measuring optical system, and a light receiving element. The EDM 11 is disposed inside the telescope 2c, and the distance-measuring optical system shares optical components with the collimation optical system. The EDM 11 emits a distance measuring light from the light emitting element, receives reflected light from a target by the light receiving element, and measures a distance to the target.

The horizontal angle detector 12 and the vertical angle detector 13 are rotary encoders. The horizontal angle detector 12 and vertical angle detector 13 detect rotation angles around rotation axes of the bracket portion 2b and the telescope 2c respectively driven by the horizontal rotation drive unit 16 and the vertical rotation drive unit 17 described later, and respectively obtain a horizontal angle and a vertical angle of a collimation optical axis A.

The EDM 11, the horizontal angle detector 12, and the vertical angle detector 13 constitute a survey unit 10 as an essential portion of the surveying instrument TS.

The tilt sensor 14 is installed in a leveling apparatus, and used to detect a tilt of a surveying instrument main body and level it horizontally.

The autocollimation unit 15 consists of a collimation optical system, a collimation light source, and an image sensor, etc., and performs autocollimation in which the automatic collimation unit 15 emits a collimation light from the collimation light source, receives reflected collimation light from a target by the image sensor, and based on results of light reception, matches a collimation optical axis with the target.

The horizontal rotation drive unit 16 and the vertical rotation drive unit 17 are motors, and are controlled by the arithmetic control unit 20. The horizontal rotation drive unit 16 rotates the bracket portion 2b horizontally. The vertical rotation drive unit 17 rotates the telescope 2c vertically.

The tracking unit 18 includes a light emitting element, a tracking optical system, and alight receiving element, and the tracking optical system shares optical elements with the distance-measuring optical system. The tracking unit 18 is configured to project an infrared laser light with a wavelength different from that of the distance measuring light onto a tracking object (target), receive reflected light from the tracking object, and track the tracking object based on results of light reception.

The arithmetic control unit 20 includes a CPU (Central Processing Unit), and a GPU (Graphical Processing Unit). The arithmetic control unit 20 performs various processings to perform functions of the surveying instrument TS.

In addition, the arithmetic control unit 20 includes, as functional units, an image recognition unit 21, an image identification unit 22, and a gesture making unit 23.

The image recognition unit 21 recognizes an image acquired by the imaging unit 46 described later. In detail, from an image acquired by the imaging unit 46, an operator's action is recognized as an input gesture.

In the specification, the term “image” includes a video image of a state where an imaging object is acting, and a still image of a state where an imaging object stops action for a certain period of time.

From input identification information, described later, in which operator's predetermined actions as input gestures are associated with operations to the surveying instrument, stored in the storage unit 30, the image identification unit 22 identifies an operation to the surveying instrument TS corresponding to the input gesture recognized by the image recognition unit 21 as content meant by the input gesture.

The gesture making unit 23 converts output content for the operator into an output gesture based on conversion information in which output contents for an operator are associated with output gestures as operations of the surveying instrument TS, stored I n the storage unit 30. The gesture making unit 23 makes an output gesture by at least rotationally driving the horizontal rotation drive unit 16 and the vertical rotation drive unit 17.

Each functional unit may be configured as software to be controlled by artificial intelligence, or may be configured by a dedicated arithmetic circuit. In addition, functional units configured as software and functional units configured by dedicated arithmetic circuits may be mixed.

The storage unit 30 includes a ROM (Read Only Memory) and a RAM (Random Access Memory).

The ROM stores programs and data necessary for operation of the entire surveying instrument TS. These programs are readout to the RAM and started to be executed by the arithmetic control unit 20, and accordingly, various processings of the surveying instrument TS according to the present embodiment are performed.

The RAM temporarily holds a program created according to software for gesture input processing and gesture output, data on gesture input and data on gesture output.

The storage unit 30 stores input identification information in which operator's predetermined actions as input gestures are associated with operations to the surveying instrument TS, and output conversion information in which output contents for an operator are associated with output gestures.

The input unit 41 is, for example, operation buttons, and with the input unit, an operator can input commands and select settings.

The display unit 42 is, for example, a liquid crystal display, and displays various information such as measurement results, environment information, and setting information in response to a command of the arithmetic control unit 20. In addition, the display unit 42 displays a command input by an operator by the input unit 41.

The input unit 41 and the display unit 42 may be configured integrally as a touch panel type display.

The first illumination light emitting unit 43 is a guide light or a laser sight, and irradiates light for giving rough guidance to a survey line. As a light source, for example, an LED that selectively emits red or green laser light is used, however, without limiting to this, one that emits visible light may be used.

The first illumination light emitting unit 43 is turned on or made to flash according to a control of the gesture making unit 23. Light of the first illumination light emitting unit 43 can be configured as an output gesture of the surveying instrument TS along with an output gesture of the telescope 2c according to the horizontal rotation drive unit 16 and the vertical rotation drive unit 17.

The second illumination light emitting unit 44 is provided at, for example, an upper portion of the surveying instrument TS main body (not illustrated in FIG. 2), and illuminates the surveying instrument TS itself. As a light source, a white LED, etc., can be used.

The third illumination light emitting unit 45 is provided on, for example, a side surface of the telescope 2c so that its optical axis becomes parallel to the collimation optical axis A. The third illumination light emitting unit 45 illuminates an operator who makes an input gesture. As a light source, a white LED, etc., can be used.

The imaging unit 46 is a means to make gesture input, and is, for example, a camera. As the camera, an RGB camera, an infrared camera, and a distance image camera capable of imaging a body movement of an operator, and an ultrasonic camera and a stereo camera capable of detecting a body movement of an operator, etc., can be used.

The imaging unit 46 is disposed at an upper portion of the telescope 2c so that its optical axis becomes parallel to the collimation optical axis A as illustrated in FIG. 2.

(Gesture Input Flow)

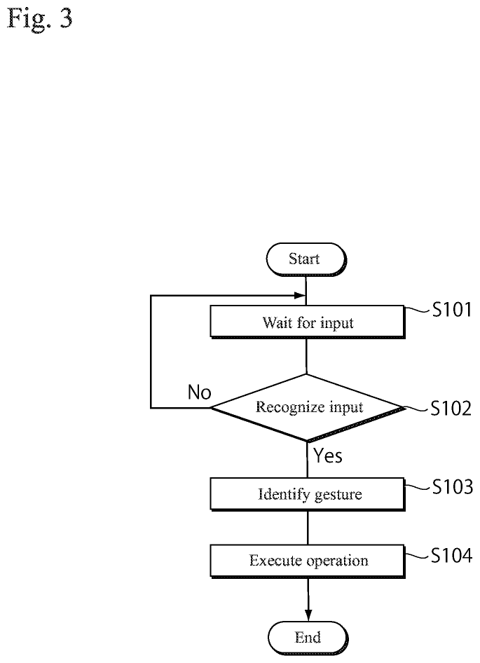

FIG. 3 is a flowchart of operation of the surveying instrument TS in gesture input.

First, when gesture input starts, in Step S101, the image recognition unit 21 waits for input of an input gesture while monitoring input of the imaging unit 46.

Next, in Step S102, the image recognition unit 21 recognizes an operator's action as an input gesture from an image acquired by the imaging unit 46.

When an image is not recognized as an input gesture (No), the processing returns to Step S101, and the image recognition unit 21 waits for input again.

When an image is recognized as an input gesture (Yes), in Step S103, the image identification unit 22 identifies an operation to the surveying instrument TS corresponding to the input gesture recognized by the image recognition unit 21 as content meant by the input gesture based on input identification information in which operator's predetermined actions as input gestures are associated with operations to the surveying instrument TS.

Next, in Step S104, based on results of identification in Step S103, the operation to the surveying instrument TS corresponding to the input gesture is executed.

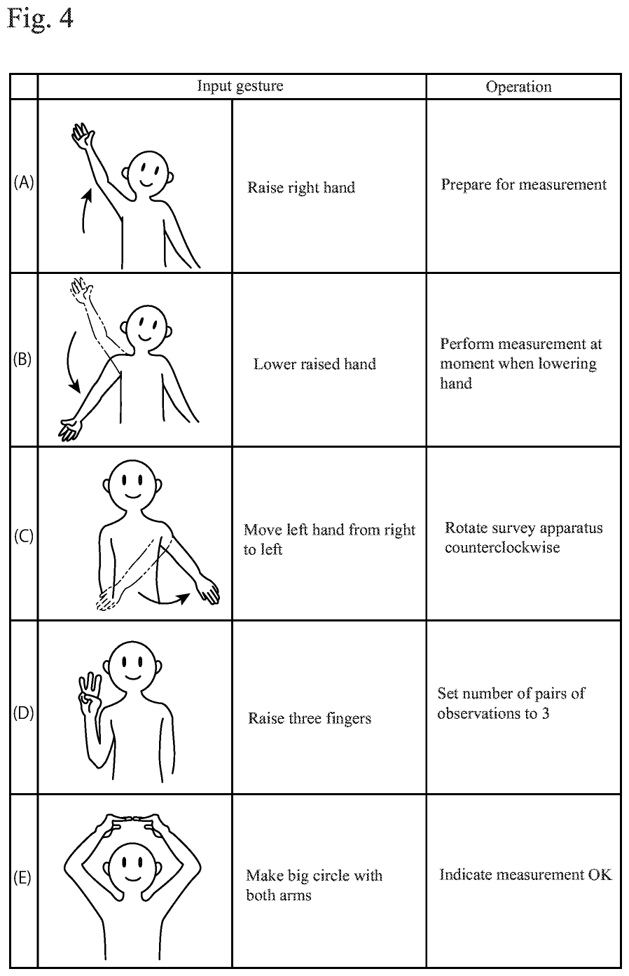

FIG. 4 illustrates examples of input gestures stored as input identification information in the storage unit 30. Hereinafter, in the description of the drawings illustrating examples of gestures of an operator and the surveying instrument TS, the “left,” “right,” “front,” and “rear” directions mean directions viewed from an operator with respect to gestures of the operator, and mean directions viewed by facing the surveying instrument TS with respect to gestures of the surveying instrument TS.

The directions of actions are just examples, and does not limit the scope of the present invention. For example, row (C) in FIG. 4 illustrates an example in which an input gesture made by moving the left hand from right to left is associated with an operation to rotate the telescope 2c counterclockwise, however, conversely, it is also possible that in response to a gesture by moving the right hand from left to right, a bilaterally symmetrical gesture such as rotating the telescope 2c clockwise can also be made.

In this way, with the surveying instrument TS according to the present embodiment, the surveying instrument TS can be made to execute a predetermined operation in response to an operator's input gesture, so that the surveying instrument TS can be operated without a direct touch. Therefore, at the time of input, there is no risk that an operator directly touches the surveying instrument and moves the surveying instrument from its installation location and changes a measurement angle of the surveying instrument, or vibrates the surveying instrument.

In the present embodiment, it is not essential to provide the third illumination light emitting unit 45 and illuminate an operator who makes an input gesture at a remote site, however, this makes it easy for the image recognition unit 21 to recognize an input gesture, and is preferable.

(Gesture Output Flow)

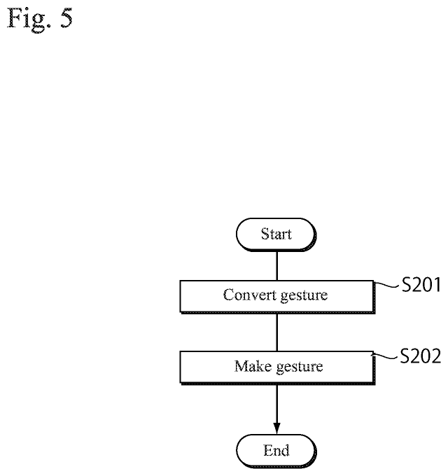

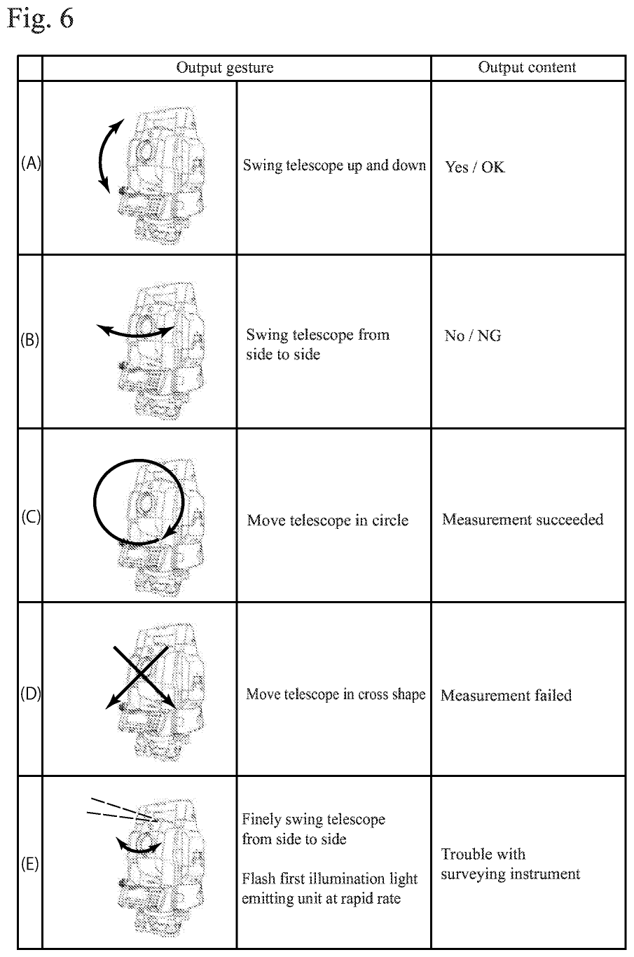

Next, operation of the surveying instrument TS in gesture output is described with reference to FIG. 5 and FIG. 6.

In the storage unit 30, output conversion information in which output contents for an operator are associated with output gestures as operations of the surveying instrument TS as illustrated in FIG. 6 are stored.

When the surveying instrument TS starts gesture output, in Step S201, the gesture making unit 23 converts output content for an operator into an output gesture based on output conversion information stored in the storage unit 30.

Next, in Step S202, the gesture making unit 23 makes a designated output gesture by controlling and rotationally driving the horizontal rotation drive unit 16 and the vertical rotation drive unit 17, and ends the processing. For example, by combining rotational driving of the horizontal rotation drive unit 16 and rotational driving of the vertical rotation drive unit 17, output gestures as illustrated in rows (A) to (D) in FIG. 6 are made.

Alternatively, it is also possible that in addition to a combination of rotational driving of the horizontal rotation drive unit 16 and rotational driving of the vertical rotation drive unit 17, light emission of the first illumination light emitting unit 43 is controlled to express an output gesture. For example, as illustrated in row (E) in FIG. 6, occurrence of a problem with the surveying instrument TS may be notified to an operator by an output gesture made by finely swinging the telescope 2c from side to side and flashing the first illumination light emitting unit 43 at a rapid rate.

In this way, with the surveying instrument TS according to the present embodiment, an instruction, etc., to an operator from the surveying instrument TS can be recognized from an output gesture of the surveying instrument TS, so that the operator can perform work without checking the display unit 42.

In addition, in the present embodiment, it is not essential that the first illumination light emitting unit 43 expresses an output gesture by lighting or flashing, etc., in response to a control of the gesture making unit 23 according to a combination of rotational driving of the horizontal rotation drive unit 16 and rotational driving of the vertical rotation drive unit 17. However, this enables dealing with various output content, and is preferable. Further, light emission of the first illumination light emitting unit 43 makes it easy to visually recognize an operation of the surveying instrument, and this is preferable.

In the present embodiment, it is not essential that the second illumination light emitting unit 44 is provided to illuminate the surveying instrument TS itself, however, this improves visibility of a gesture of the surveying instrument TS when an operator is at a remote site, and is preferable.

A list of input identification information and output conversion information is editable although it may be set in advance before shipment. Alternatively, the list may be configured so as to be set by an operator as needed from a predetermined function of the surveying instrument.

Alternatively, the surveying instrument may be configured to automatically add and accumulate set content by autonomously learning a permissible range to avoid errors due to physical differences among a plurality of operators and differences in action among gestures from results of recognition by the image recognition unit 21 and results of identification by the image identification unit 22.

### Example 1

(As-Built Survey Using Gesture Interface)

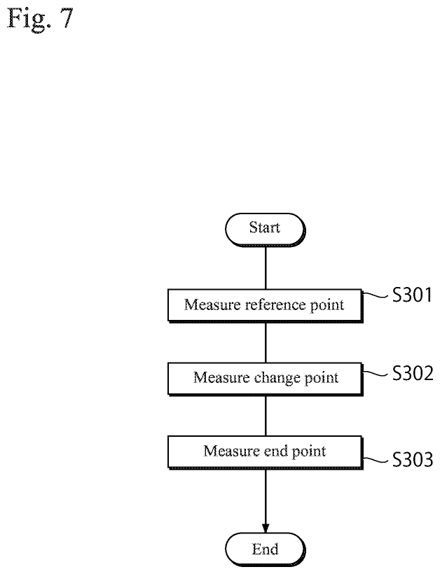

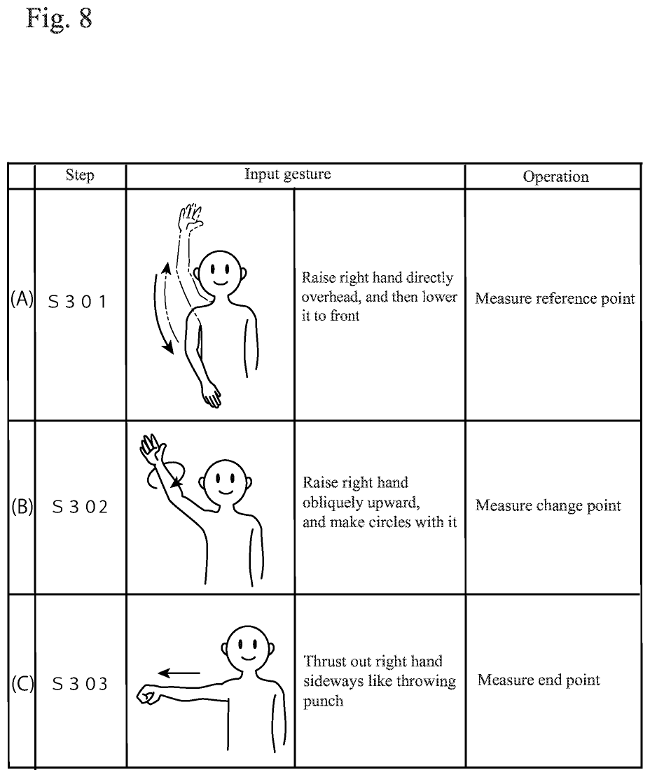

An example of an as-built survey using the gesture interface of the surveying instrument TS described above is described with reference to FIG. 7 and FIG. 8.

FIG. 7 is a flowchart of operation of the surveying instrument TS relating to an as-built survey. In an as-built survey, the surveying instrument TS is made to read coordinate data of a reference point in advance, and store the coordinate data in the storage unit 30. When an operator sets the surveying instrument TS and starts an as-built survey operation, the operator moves to the reference point with a pole prism (a pointer with a prism provided at an upper portion).

In Step S301, at the reference point, the operator faces the surveying instrument TS, and when the operator makes an input gesture by raising his/her right hand directly overhead and then lowering it to the front, as illustrated in row (A) in FIG. 8, the surveying instrument TS measures the reference point. After the measurement ends, the operator moves to a change point (a point where the slope of the ground changes).

Next, in Step S302, at the change point, when the operator faces the surveying instrument TS and makes an input gesture by raising his/her right hand obliquely upward and making circles with it, as illustrated in row (B) in FIG. 8, the surveying instrument TS measures the change point. After the measurement ends, the operator moves to an end point.

Next, in Step S303, at the end point, when the operator faces the surveying instrument TS and makes an input gesture by thrusting out his/her right hand sideways like throwing a punch, as illustrated in row (C) in FIG. 8, the surveying instrument TS measures the end point. After the measurement ends, the surveying instrument TS ends the processing.

In each measurement, the surveying instrument TS may be configured to notify an operator of an end of each measurement by turning-on the first illumination light emitting unit 43.

Normally, an as-built survey is taken by an operator on the surveying instrument TS side and an operator on the pole prism side who work together as a pair in such a way that the operator on the surveying instrument TS side cooperates with the operator on the pole prism side while operating the surveying instrument.

However, with the surveying instrument TS according to the present embodiment, the operator on the pole prism side can remotely operate the surveying instrument TS by an input gesture, so that the operator on the pole prism side can take an as-built survey alone.

### Example 2

(Staking Using Gesture Interface)

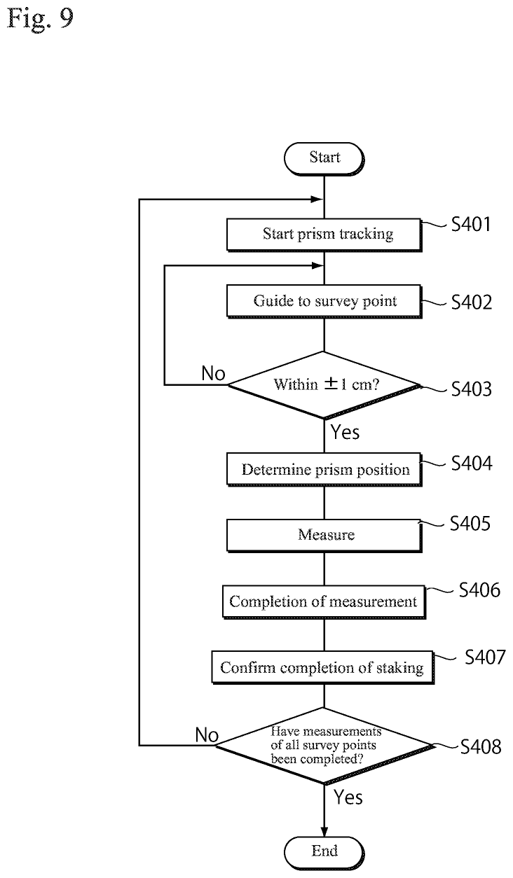

Examples of staking using the gesture interface of the surveying instrument TS described above are described with reference to FIG. 9 to FIG. 11.

FIG. 9 is a flowchart of operation of the surveying instrument TS relating to staking. The surveying instrument TS is made to read design value data of a plurality of survey points where staking is performed in advance. First, an operator sets the surveying instrument TS, starts execution of a staking program, and moves to a first survey point with the pole prism.

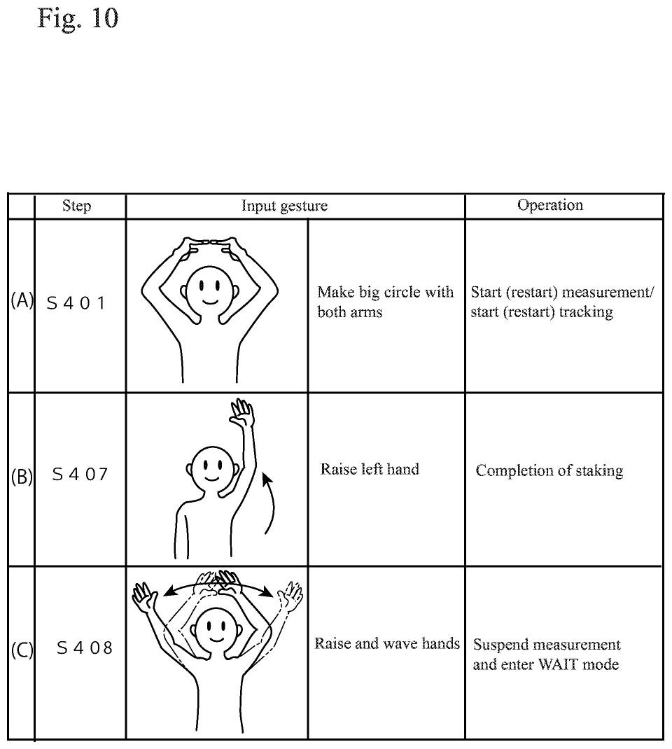

When the operator comes near the first survey point, the operator instructs the surveying instrument TS to start prism tracking by making an input gesture by, for example, making a big circle with both arms as illustrated in row (A) in FIG. 10. Then, the surveying instrument TS starts prism tracking in Step S401.

Next, in Step S402, the surveying instrument TS compares a current position of the pole prism and a position of the set first survey point to calculate a direction in which the pole prism approaches the survey point and a distance to the survey point. The surveying instrument TS guides the operator by a gesture so that the pole prism matches the survey point.

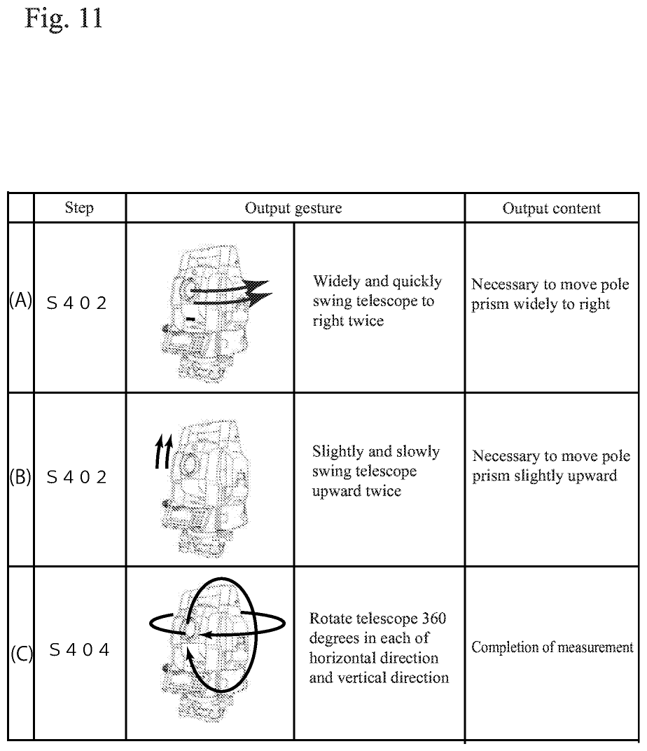

In detail, for example, when it is necessary to move the pole prism widely to the right, as illustrated in row (A) in FIG. 11, the telescope 2c is widely swung to the right twice. Alternatively, when it is necessary to move the pole prism slightly upward, the telescope 2c is slowly swung upward twice as illustrated in row (B) in FIG. 11. Accordingly, the operator moves the pole prism according to the instruction from the surveying instrument TS.

Next, in Step S403, the surveying instrument TS determines whether the pole prism has matched the first survey point, for example, whether the pole prism has entered within a range of ±1 cm from the survey point.

When the pole prism does not enter within the range of ±1 cm from the survey point (No), the processing returns to Step S402, and the surveying instrument TS performs guidance to the survey point by an output gesture again.

On the other hand, when the pole prism enters within the range of ±1 cm from the survey point (Yes), in Step S404, the position of the pole prism is determined to be a staking point.

Next, in Step S405, the surveying instrument TS measures the pole prism. After the measurement ends, in Step S405, as illustrated in row (C) in FIG. 11, the surveying instrument TS rotates the telescope 2c 360 degrees in each of the horizontal direction and the vertical direction, and outputs an end of the measurement by a gesture.

After the measurement is completed, the operator performs staking, and for example, as illustrated in row (B) in FIG. 10, reports completion of staking to the surveying instrument TS by a gesture. The surveying instrument TS confirms an input in Step S407.

Next, in Step S408, the surveying instrument TS determines whether measurements of all survey points set in advance have been ended.

In a case where measurements of all survey points have been ended (Yes), the staking processing ends.

On the other hand, in a case where measurements of all survey points have not been ended (No), the processing returns to Step S401, prism tracking with respect to the next survey point is started, and the processings of Steps S401 to S405 are repeated until staking is completed for all survey points.

In the present example, the tracking unit 18 is set so as to start automatic tracking in response to a gesture input by an operator and automatically track a survey point based on design value data. However, the tracking unit 18 may be configured so as to start automatic tracking of the surveying instrument TS when an operator moves from the surveying instrument TS, and continue automatic tracking.

The surveying instrument TS may be configured to suspend tracking and enter a WAIT mode when an operator inputs the input gesture illustrated in row (C) in FIG. 10 after Step S408 and before moving to the next survey point.

Normally, staking is performed by an operator on the surveying instrument TS side and an operator on the pole prism side, who work together as a pair in such a way that the operator on the surveying instrument TS side cooperates with the operator on the pole prism side while operating the surveying instrument.

However, with the surveying instrument TS according to the present embodiment, the operator on the pole prism side can remotely operate the surveying instrument TS by an input gesture, and can check an operation state of the surveying instrument TS side from an output gesture, so that the operator on the pole prism side can perform staking alone.

### Modification

In the present embodiment, a remote controller capable of remotely operating the surveying instrument TS may be provided, and an input may be made by the remote controller instead of gesture input, and only output may be made by gesture output of the surveying instrument TS.

### Second Embodiment

(Configuration of Surveying Instrument)

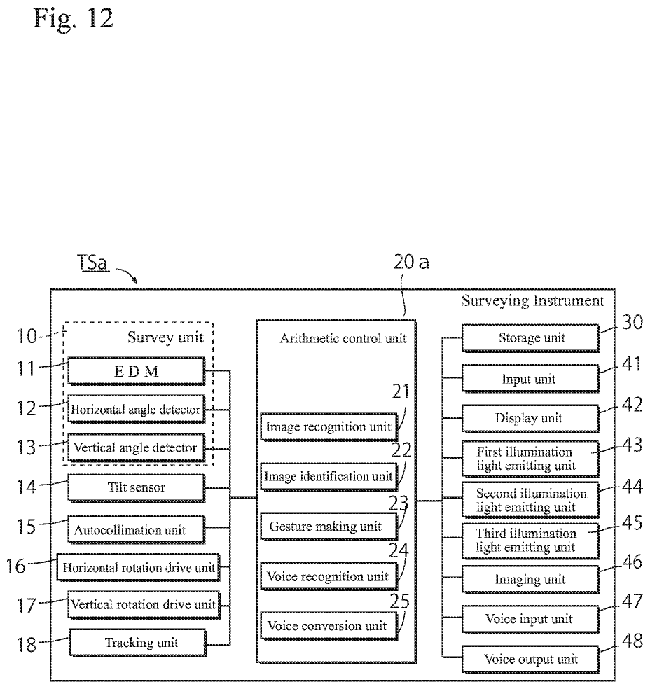

FIG. 12 is a configuration block diagram of a surveying instrument TSa according to a second embodiment of the present invention. The surveying instrument TSa is different from the surveying instrument TS according to the first embodiment in that the surveying instrument TSa includes a voice input unit 47 and a voice output unit 48 in addition to the components of the surveying instrument TS. In addition, the surveying instrument TSa is different in that the arithmetic control unit 20a includes a voice recognition unit 24 and a voice conversion unit 25 in addition to the components of the arithmetic control unit 20 according to the first embodiment.

The voice input unit 47 is a means to input voice, and is, for example, a sound concentrating microphone or a directional microphone. The voice input unit 47 is provided in the bracket portion 2b. The voice input unit 47 collects voice produced by an operator, converts it into a voice signal and outputs the voice signal to the arithmetic control unit 20a.

The voice output unit 48 is a means to output voice, and is, for example, a speaker. The voice output unit 48 is provided in the bracket portion 2b. The voice output unit 48 outputs a message output from the voice conversion unit 25 as voice based on an instruction from the arithmetic control unit 20a.

The voice recognition unit 24 recognizes voice input from the voice input unit 47 by a natural language processing function, and converts it into a text command.

The voice conversion unit 25 converts output content for the operator output from the arithmetic control unit 20a into a voice message, and outputs the voice message to the voice output unit 48.

(Input Flow)

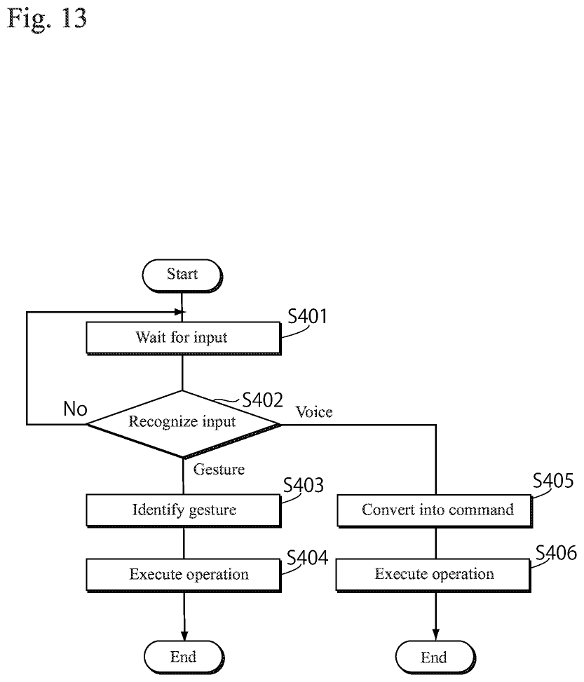

FIG. 13 is a flowchart of an operation of the surveying instrument TSa when a gesture input and a voice input are combined.

First, when an input mode starts, in Step S401, the image recognition unit 21 and the voice recognition unit 24 wait for an input while monitoring inputs of the imaging unit 46 and the voice input unit 47.

Next, in Step S402, when an image or voice input is made, the image recognition unit 21 and the voice recognition unit 24 detect the input, and when an image is input, from the image acquired by the imaging unit 46, the image is recognized as an input gesture. When voice is input, voice acquired by the voice input unit 47 is recognized as an input voice.

In Step S402, when neither an image nor voice is recognized (No), the processing returns to Step S401, and the image recognition unit 21 and the voice recognition unit 24 wait for an input again.

In Step S402, when an image is recognized as an input gesture (gesture), in Step S403, based on input identification information in which operator's predetermined actions as input gestures are associated with operations to the surveying instrument stored in the storage unit 30, the image identification unit 22 identifies an operation of the surveying instrument TS corresponding to the input gesture recognized by the image recognition unit 21 as content meant by the input gesture.

Next, in Step S404, based on results of identification in Step S403, the operation to the surveying instrument TS corresponding to the input gesture is executed, and the input is ended.

In Step S403, when voice is recognized as an input voice (voice), in Step S405, the voice recognition unit 24 converts the input voice into a text command.

Next, in Step S406, an operation corresponding to the command is executed, and the input is ended.

(Output Flow)

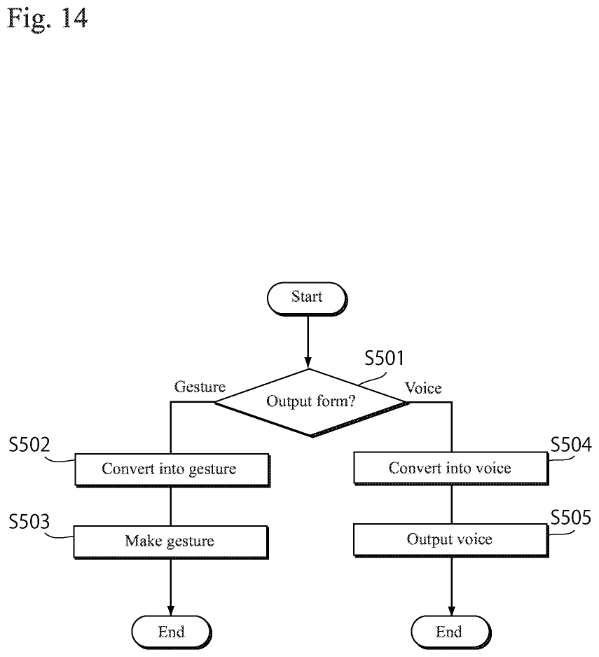

FIG. 14 is a flowchart of operation of the surveying instrument TSa when a gesture output and a voice output are combined.

When an output is generated, in Step S501, the arithmetic control unit 20a selects an output form determined in advance for output content.

In Step S501, when the output form is a gesture (gesture), in Step S502, the gesture making unit 23 converts output content for an operator into an output gesture based on output conversion information stored in the storage unit 30.

Next, in Step S503, the gesture making unit 23 makes a designated output gesture by controlling and rotationally driving the horizontal rotation drive unit 16 and the vertical rotation drive unit 17, and ends the processing.

On the other hand, in Step S501, when the output form is voice (voice), in Step S504, the voice conversion unit 25 converts output content into a voice message corresponding to the output content, and outputs the voice message to the voice output unit 48.

Next, in Step S505, the voice output unit 48 outputs the voice message input from the voice conversion unit 25 as voice, and ends the processing.

In this way, the gesture interface according to the first embodiment can be applied to the surveying instrument TSa even when using voice input and output.

Although preferred embodiments of the present invention are described above, the embodiments and examples described above are just examples of the present invention, and the respective configurations can be combined based on knowledge of a person skilled in the art, and such a combined embodiment is also included in the scope of the present invention.

### REFERENCE SIGNS LIST

TS Surveying instrument
TSa Surveying instrument
2c Telescope
16 Horizontal rotation drive unit
17 Vertical rotation drive unit
20 Arithmetic control unit
20a Arithmetic control unit
21 Image recognition unit
22 Image identification unit
23 Gesture making unit
24 Voice recognition unit
25 Voice conversion unit
30 Storage unit
43 First illumination light emitting unit
44 Second illumination light emitting unit
45 Third illumination light emitting unit
46 Imaging unit

1. A surveying instrument comprising:
a survey unit capable of surveying a target;
an imaging unit capable of acquiring an image;
an arithmetic control unit configured to control the survey unit and the imaging unit; and
a storage unit, wherein
the storage unit has input identification information in which an operator's predetermined action as an input gesture is associated with an operation to the surveying instrument, and
the arithmetic control unit includes an image recognition unit configured to recognize an input gesture from the image, and an image identification unit configured to identify an operation to the surveying instrument corresponding to the input gesture recognized by the image recognition unit as content meant by the input gesture.

2. A surveying instrument comprising:
a survey unit capable of surveying a target;
a telescope including the survey unit;
a horizontal rotation drive unit configured to rotate the telescope horizontally around a vertical axis;
a vertical rotation drive unit configured to rotate the telescope vertically around a horizontal axis;
an arithmetic control unit configured to control the survey unit, the horizontal rotation drive unit, and the vertical rotation drive unit; and
a storage unit, wherein
the storage unit has output conversion information in which output content for an operator is associated with an output gesture as an operation of the surveying instrument, and
the arithmetic control unit includes a gesture making unit configured to convert output content for an operator into an output gesture based on the output conversion information, and make an output gesture by rotationally driving at least one of the horizontal rotation drive unit and the vertical rotation drive unit.

3. The surveying instrument according to claim 1, comprising:
a telescope including the survey unit;
a horizontal rotation drive unit configured to rotate the telescope horizontally around a vertical axis;
a vertical rotation drive unit configured to rotate the telescope vertically around a horizontal axis;
an arithmetic control unit configured to control the survey unit, the horizontal rotation drive unit, and the vertical rotation drive unit; and
a storage unit, wherein
the storage unit has output conversion information in which output content for an operator is associated with an output gesture as an operation of the surveying instrument, and
the arithmetic control unit includes a gesture making unit configured to convert output content for an operator into an output gesture based on the output conversion information, and make an output gesture by rotationally driving at least one of the horizontal rotation drive unit and the vertical rotation drive unit.

4. The surveying instrument according to claim 2, comprising:
a first illumination light emitting unit, wherein
the gesture making unit is configured to express a gesture by controlling the first illumination light emitting unit.

5. The surveying instrument according to claim 3, comprising:
a first illumination light emitting unit, wherein
the gesture making unit is configured to express a gesture by controlling the first illumination light emitting unit.

6. The surveying instrument according to claim 2, comprising:
a second illumination light emitting unit, wherein
the second illumination light emitting unit is configured to illuminate the surveying instrument itself.

7. The surveying instrument according to claim 3, comprising:
a second illumination light emitting unit, wherein
the second illumination light emitting unit is configured to illuminate the surveying instrument itself.

8. The surveying instrument according to claim 1, comprising:
a third illumination light emitting unit, wherein
the third illumination light emitting unit is configured to illuminate an operator who makes the input gesture.

9. The surveying instrument according to claim 3, comprising:
a third illumination light emitting unit, wherein
the third illumination light emitting unit is configured to illuminate an operator who makes the input gesture.

10. The surveying instrument according to claim 1, comprising:
a voice input unit; and
a voice output unit, wherein
the arithmetic control unit includes a voice recognition unit configured to recognize voice input from the voice input unit, and a voice conversion unit configured to convert output content for an operator into a voice message, and output the voice message to the voice output unit.

11. The surveying instrument according to claim 2, comprising:
a voice input unit; and
a voice output unit, wherein
the arithmetic control unit includes a voice recognition unit configured to recognize voice input from the voice input unit, and a voice conversion unit configured to convert output content for an operator into a voice message, and output the voice message to the voice output unit.

12. The surveying instrument according to claim 3, comprising:
a voice input unit; and
a voice output unit, wherein
the arithmetic control unit includes a voice recognition unit configured to recognize voice input from the voice input unit, and a voice conversion unit configured to convert output content for an operator into a voice message, and output the voice message to the voice output unit.
